(19) United States
(12) Patent Application Publication
(10) Pub. No.: US 2013/0033059 A1
(43) Pub. Date: Feb. 7, 2013

(54) INSERTED AUXILIARY SUN VISOR FOR VEHICLES

(71) Applicant: Allen C. Liu, Dover, MA (US)

(72) Inventor: Allen C. Liu, Dover, MA (US)

(21) Appl. No.: 13/562,702

(22) Filed: Jul. 31, 2012

Related U.S. Application Data
(60) Provisional application No. 61/514,281, filed on Aug. 2, 2011.

(51) Int. Cl. B60J 3/06; B60J 3/02

(52) U.S. Cl. 296/97.2; 296/97.11

(57) ABSTRACT

The invention involves an improved auxiliary sun visor for vehicles, for example, automobiles. It comprises a transparent and colored light-shielding plate inserted into sun visor to dim and reduce sunlight. The inside shielding plate can be flexibly pulled out for use and pushed back in when not being used. The built-in shielding plate looks more aesthetically appealing compared to the original attached style.

### BACKGROUND

1. Field of the Invention

The invention relates to an improved auxiliary sun visor inserted into a conventional sun visor.

2. Description of the Prior Art

Current auxiliary sun visors directly attach a transparent and colored light-shielding plate to the ordinary sun visor using clips or strips. The light-shielding plate is also capable of changing its angle on the hinges. Whenever the driver feels blinded by the harsh sunlight, he or she can pull down the regular sun visor and extends the auxiliary sun visor even lower to protect against light glare. If the sunlight is not harsh, then the auxiliary sun visor is folded onto the back of the regular sun visor, out of the way.

However, the externally attached auxiliary sun visor is not aesthetically pleasing. It folds away from the sun visor and looks bulky in size.

### SUMMARY OF THE INVENTION

An auxiliary sun visor which dims the sun's rays with a transparent and colored light-shielding plate is extremely helpful when the driver is blinded by the glare of direct sun light. An internal built-in transparent and colored light-shielding plate within the default sun visor can slide in or out of the sun visor depending on the degree of sunlight. The transparent and colored light-shielding plate can be inserted into a slot on the bottom side of the conventional sun visor. When the driver does not need to limit exposure to the sunlight, he or she can easily retract the plate back into the regular sun visor. As soon as the driver becomes impacted by sunlight, he or she can pull out the light-shielding plate to lessen the effects of the sunlight. The position of the transparent and colored light-shield plate from the sun visor is adjustable depending on the driver's preferences. The transparent and colored light-shield plate can include a polymer-structured material or glass.

### BRIEF DESCRIPTION OF THE DRAWINGS

FIG. 1 is a perspective view of the sun visor with a slot.

FIG. 2 is a perspective view of the transparent and colored light-shielding plate.

FIG. 3 is a perspective view of half sun visor.

FIG. 3a is a perspective view of two layers of polymer ribbons.

FIG. 4 is a perspective view of the transparent and colored light-shielding plate in the inside of sun visor.

FIG. 5a is a perspective view of the fully retracted transparent and colored light-shielding plate back in sun visor.

FIG. 5b is a perspective view of the partially extended transparent and colored light-shielding plate out.

FIG. 5c is a perspective view of the fully extended transparent and colored light-shielding plate out.

### DETAILED DESCRIPTION

An auxiliary sun visor for a vehicle can include a base plate in an interior region of a sun visor of a vehicle. The base plate can be configured to slide in to and out of the sun visor. The interior region of the sun visor can include a polymer ribbon configured to hold the base plate in a selected position. The position of the base plate in the sun visor can be movable and adjustable, for example, it can be fully pulled out and fully retracted back, or positions somewhere in between at a position selected by the user. For example, the user extends the base plate from the interior region of the visor to a position that blocks or reduces sun light while maintaining visibility of surroundings.

The base plate can be a transparent and colored light-shielding plate. The color of the transparent and colored light-shielding plate can be selected to reduce the intensity of sun light. For example, the color can be amber, yellow, gold, gray, brown, blue, orange, green, purple, rose, or red. In certain embodiments, the transparent and colored light-shielding plate can be polarized.

The base plate can include a polymer or glass region. For example, the polymer or glass region includes poly(methyl methacrylate) (PMMA), polycarbonate (PC), polyethylene terephthalate (PET), polymethylpentene (PMP), polyvinylidene fluoride (PVDF), polysulfone (PSF), polystyrene (PS), polyether sulfone (PES), styrene/acrylonitrile copolymer (SAN), or blends thereof.

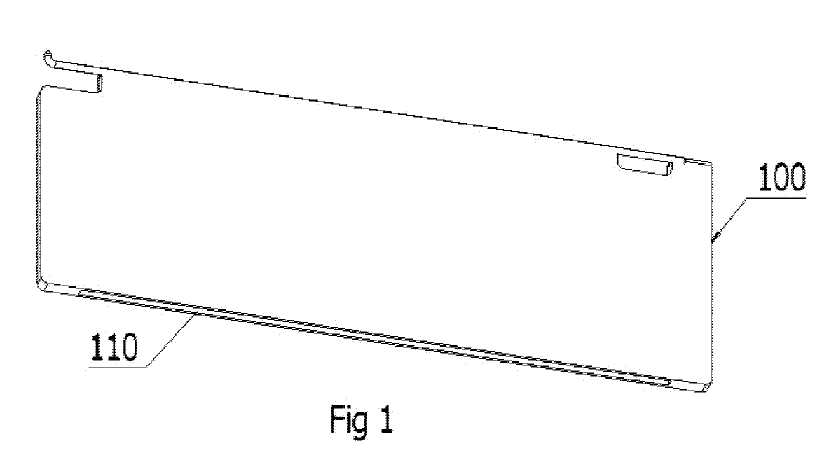

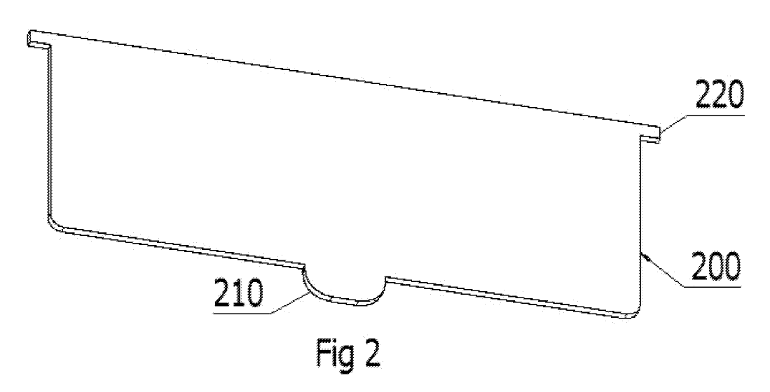

An embodiment of this invention is described with reference to the drawings. FIG. 1 shows an innovative sun visor 100 with a slot 110 in the bottom side. The sun visor can be made of plastic. The transparent and colored light-shielding plate 200 with a handle 210 can have projecting pieces 220 on the top as shown in FIG. 2.

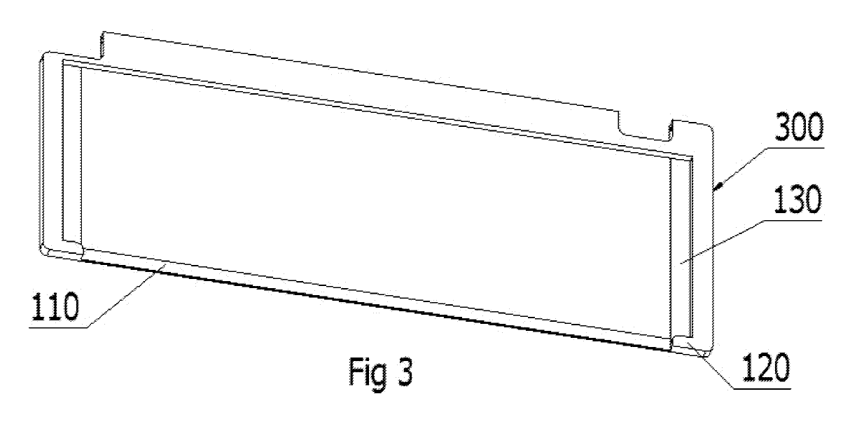

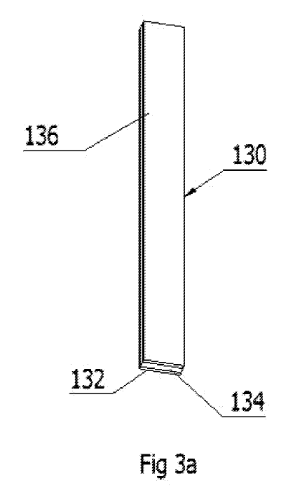

The transparent and colored light-shielding plate 200 can be made of polymer or glass. The polymer material can include poly(methyl methacrylate) (PMMA), polycarbonate (PC), polyethylene terephthalate (PET), polymethylpentene (PMP), Polyvinylidene fluoride (PVDF), polysulfone (PSF), polystyrene (PS), or polyether sulfone (PES), or other mixed polymers such as LURAN (SAN), and ULTRASON (PES and PSU), or other transparent polymers. The color of transparent light-shielding plate selected can be amber tint, yellow tint, gold tint, gray tint, brown tint, blue tint, green tint, purple tint, rose tint, or other colors which can dim sunlight. The transparent and colored light-shielding plate can either be polarized or non-polarized. FIG. 3 shows a half sun visor 300, which can include projecting pieces 120 and two layers of ribbons 130 in each side of sun visor.

FIG. 3a shows that ribbon 130 can include polymers 134 and 136 two layers on the sun visor base 132. The polymer ribbon 134 can provide certain elasticity to hold the transparent and colored light-shielding plate 200 at any position without sliding. The soft polymer ribbon 136 can provide certain friction to hold the transparent and colored light-shielding plate 200 at any position without sliding, as well as prevent scratches on shielding plate 200. Polymer ribbon 136 can be adhered to polymer ribbon 134, which then can be adhered to sun visor base 132. The polymer ribbon 134 can include polymer foam or rubber, and polymer ribbon 136 can include polymer rubber or chemical fiber such as polyester. Two layers of polymer ribbons 130 can have multiple combinations of fiber, elastic and foam materials depend on efficiency. The combination may be polymer foam with fiber, polymer foam with rubber, or rubber with fiber.

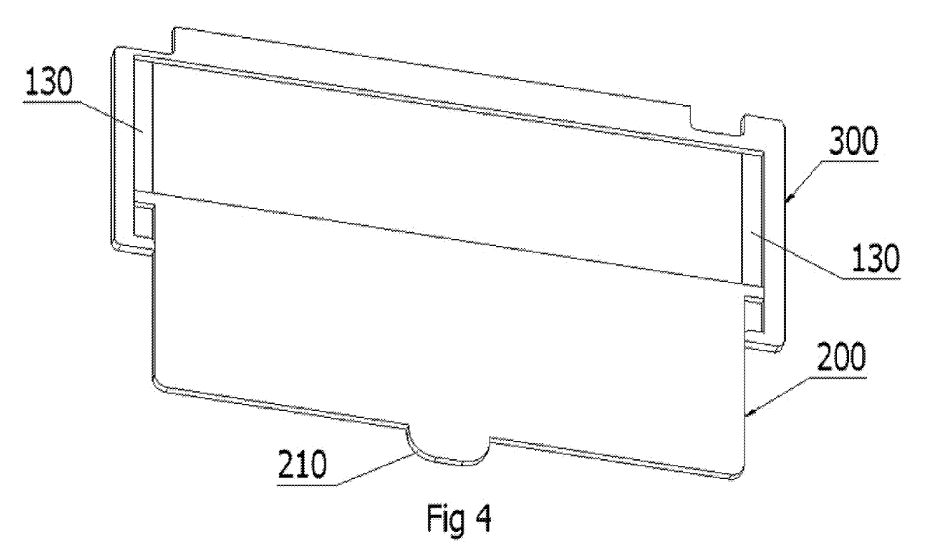

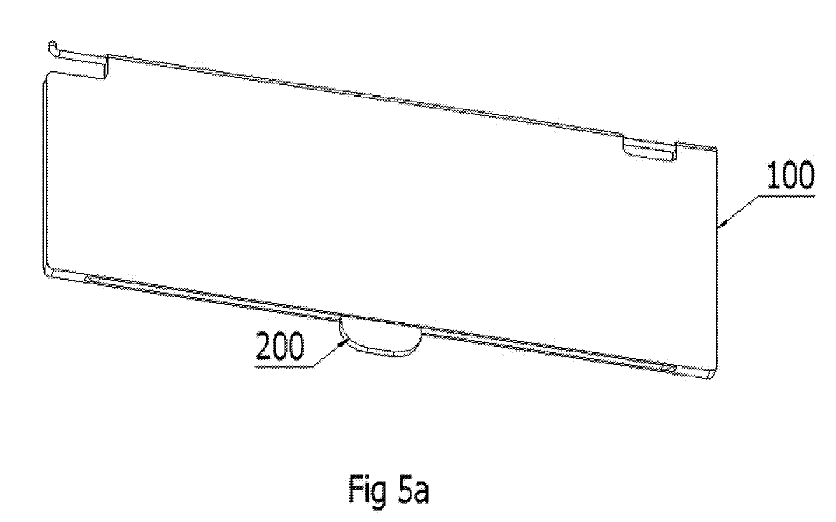

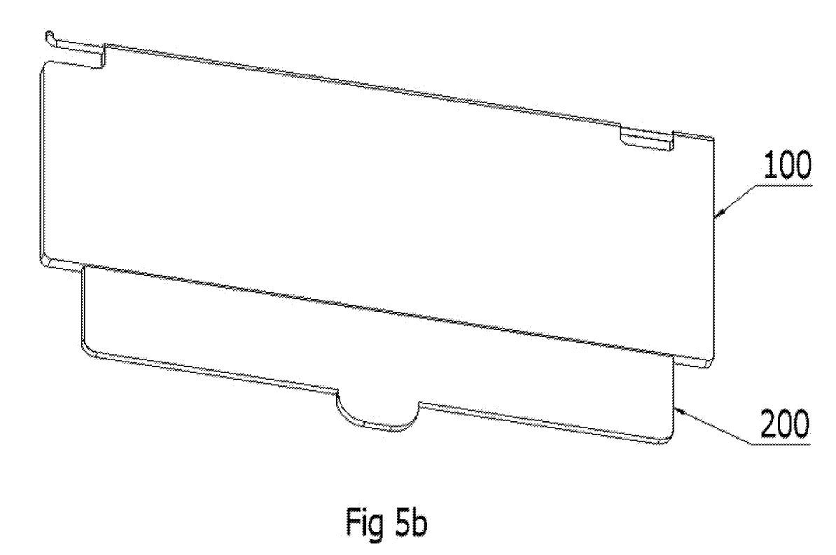

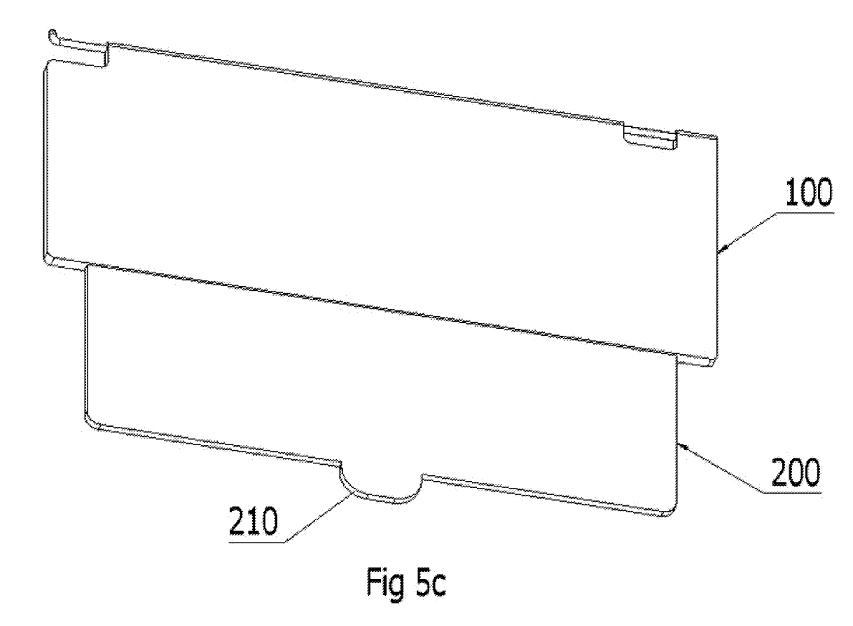

FIG. 4 shows that the projecting pieces 120 of sun visor 300 blocks the projecting pieces 220 of transparent and colored light-shielding plate 200 to prevent from falling down. The twohalf mirror symmetrical sun visors 300 can be assembled into a whole sun visor 100 with screws or adhesives. The perspective view of the built-in transparent and colored light-shielding plate 200 is assembled within sun visor 100 as shown in FIG. 5a, in which the plate 200 can be fully retracted back in sun visor 100. FIG. 5b shows the transparent and colored light-shielding plate 200 partially extended out of sun visor 100. FIG. 5c shows the transparent and colored light-shielding plate 200 fully pulled out of sun visor 100.

It is to be understood that the present invention is not limited to the embodiments described above, but encompasses any and all embodiments within the scope of the following claims.

What is claimed is:

1. An auxiliary sun visor for a vehicle comprising a base plate in an interior region of a sun visor of a vehicle, the base plate being configured to slide in to and out of the sun visor.

2. An auxiliary sun visor according to claim 1, wherein said base plate is a transparent and colored light-shielding plate.

3. An auxiliary sun visor according to claim 2, wherein said transparent and colored light-shielding plate includes a polymer or glass region.

4. An auxiliary sun visor according to claim 3, wherein said color of the transparent and colored light-shielding plate is amber, yellow, gold, gray, brown, blue, orange, green, purple, rose, or red.

5. An auxiliary sun visor according to claim 3, wherein said transparent and colored light-shielding plate is polarized.

6. An auxiliary sun visor according to claim 3, wherein said transparent and colored light-shielding plate is non-polarized.

7. An auxiliary sun visor according to claim 3 wherein said polymer or glass region includes poly(methyl methacrylate) (PMMA), polycarbonate (PC), polyethylene terephthalate (PET), polymethylpentene (PMP), polyvinylidene fluoride (PVDF), polysulfone (PSF), polystyrene (PS), polyether sulfone (PES), styrene/acrylonitrile copolymer (SAN), or blends thereof.

8. An auxiliary sun visor according to claim 1, wherein said interior region of the sun visor includes a polymer ribbons configured to hold the transparent and colored light-shielding plate in a selected position.

9. An auxiliary sun visor according to claim 2, wherein said position of the transparent and colored light-shielding plate in the sun visor is movable and adjustable.

10. An auxiliary sun visor according to claim 8, wherein said transparent and colored light-shielding plate in the sun visor is configured to be fully pulled out and fully retracted back.

11. A method of adjusting the width of a sun visor comprising:
extending a base plate from an interior region of the sun visor.

12. The method of claim 11, wherein the base plate is a transparent and colored light-shielding plate.

13. The method of claim 11, wherein the position of the base plate is adjusted relative to the sun visor.
